(19) United States
(12) Patent Application Publication
(10) Pub. No.: US 2001/0040350 A1
(43) Pub. Date: Nov. 15, 2001

(54) GOLF BAG CART

(76) Inventors: WILLIAM J. ALLEN, COLCHESTER, VT (US); PHILIP P. TRABULSY, COLCHESTER, VT (US); MARIO E. TRABULSY, COLCHESTER, VT (US)

Correspondence Address: JAMES MARC LEAS, 37 BUTLER DRIVE, S. BURLINGTON, VT, 05403, US

(21) Appl. No.: 09/187,373

(22) Filed: Nov. 6, 1998

(51) Int. Cl. B62D 51/04; B62B 1/00

(52) U.S. Cl. 280/1.5; 280/47.315; 280/DIG. 6

(57) ABSTRACT

A golf bag cart handle assembly is provided for pushing a golf bag cart. In use the handle wraps around at least a portion of the golfer's body and presents the golfer with horizontal and vertical gripping positions directly in front of the golfer. A preferred embodiment of the handle assembly comprises connecting means for attachment to the golf bag cart, height, length, and tilt adjustment means, an outward member bending away from the major longitudinal axis of the golf bag cart, a first horizontal member, a first vertical member bending upward, a horizontal transverse member perpendicular to the major longitudinal axis of the golf bag cart, a second downward vertical member and a second horizontal member. Also disclosed is a belt-mounted pulling assembly that clips onto the handle to allow pulling of the cart.

### TECHNICAL FIELD

The present invention relates to the field of golf, more specifically, it relates to golf bag carts and especially an apparatus for pulling or pushing a golf bag cart.

### BACKGROUND ART

The sport of golf requires golfers to carry a substantial amount of equipment, such as golf clubs, golf balls, and golf tees with them on the golf course. Additional personal equipment may also be carried by the golfers. This equipment is usually carried in a golf bag or golf bag cart. A golf bag cart often consists of a golf bag fitted with wheels and a handle for pulling the golf bag cart. Such a golf bag cart is described in U.S. Pat. No. 3,334,910 to Wilson et al., which is hereby incorporated by reference. A golf bag cart filled with equipment can become quite heavy. Pulling the golf bag cart filled with equipment leads to fatigue of the legs, and of the arm pulling the cart, partly because of the weight and partly because of the awkward angle presented by the handle of the golf bag cart. Maneuvering of the cart can also place stress on the grasping hand, the arm, and the shoulder. This stress can lead to muscle or joint pain, poorer performance, and reduced enjoyment of the game.

To overcome these problems several methods of pulling a golf bag cart have been described.

U.S. Pat. No. 2,559,981 to McBride discloses an attachment for the handle of a golf bag cart, which handle releasably couples into a holster worn on the side of the golfer's belt.

U.S. Pat. No. 3,328,043 to Johnson discloses a clamp pivotably mounted to the center of the back region of a belt for clamping onto the handle of a golf bag cart.

U.S. Pat. No. 3,311,385 to Frantz discloses a wire clip for capturing the handle of a golf bag cart mounted to a planar member that slides over the center back portion of a golfer's belt.

U.S. Pat. No. 4,236,723 to Lemmon discloses a cart designed to carry a load and to be pulled behind a user when strapped to the waist or hips. The cart contains a generally upright, adjustable-length load-support frame.

### DISCLOSURE OF INVENTION

Disclosed herein is an apparatus directly mountable to the golf bag cart for pushing the golf cart bag. The apparatus is in the form of a handle assembly that wraps around the golfer and presents the golfer with a choice between a long transverse horizontal member and short, substantially vertical members to grip the handle with one or both of the golfer's hands, as well as providing locations for resting the golfer's elbows. At the rear of the handle assembly an outward member bends back behind the golfer before being attached to the cart so as to keep the cart and the golfer properly in alignment. The cart is pushed with the arms of the golfer extending forward and approximately parallel to the ground. This provides a less fatiguing grip on the handle and increased comfort of the golfer's upper extremity muscles. In order to increase comfort, the handle may be provided with cushioned hand grips and elbow pads. It is therefore a purpose of the present invention to provide a golf cart handle for towing a golf bag cart while pushing forward.

Thus, generally, the invention provides a handle for a golf bag cart for use by a golfer while transporting a golf bag load, the handle having a gripping portion for gripping by the golfer, the gripping portion being disposed adjacent to a forward end of the handle and forward of the golfer while the golf bag load is carried behind the golfer. To achieve this purpose, the handle preferably extends from the golf bag cart around at least a portion of the golfer's body, preferably from the posterior of the golfer's body to the anterior of the golfer's body.

Even with the comfort provided for pushing the golf bag cart using the golf bag cart handle of the present invention, the need may arise to pull the cart. The long horizontal grip portion of the handle provides a stable platform for either pulling the cart behind the golfer in a conventional manner with either hand or by detachably attaching a belt-mounted pulling apparatus to the handle. A pair of spaced-apart clips is attached to the center back portion of a belt. These clips engage the transverse horizontal member. Having the ability to both push and pull the cart allows the golfer to switch between either means as fatigue or other circumstances dictate. Therefore it is a further purpose of the present invention to provide a belt for attaching to the disclosed handle to allow pulling of the golf bag cart.

### BRIEF DESCRIPTION OF DRAWINGS

The novel features believed characteristic of the invention are set forth in the appended claims. The invention itself however, as well as a preferred mode of use, and further objects and advantages thereof, will best be understood by reference to the following detailed description of an illustrative embodiment when read in conjunction with the accompanying drawings, wherein:

FIG. 1 is a side view of a golf cart handle made in accordance with the present invention.

FIG. 2 is a top plan view of a golf cart handle made in accordance with the present invention.

FIG. 3 is a front elevation view of a golf cart handle made in accordance with the present invention.

FIG. 4 is a partial side view of a connecting assembly for attaching a golf cart handle to a golf bag cart.

FIG. 5 is a partial top view of a tilting assembly of the golf cart handle.

FIG. 6 is a side elevation view schematic diagram of a golf bag cart handle in use in pushing mode.

FIG. 7 is a side elevation view schematic diagram of the golf bag cart handle in use in pulling mode.

FIG. 8 is a perspective view of a belt pulling assembly made in accordance with the present invention.

FIG. 9 is a partial front view of the belt pulling assembly.

FIG. 10 is a partial top view of the belt pulling assembly.

FIG. 11 is a cross-sectional view through section 9-9 of FIG. 9.

FIG. 12 is a cross-sectional view of a first alternative embodiment through section 9-9 of FIG. 9.

FIG. 13 is a cross-sectional view of a second alternative embodiment through section 9-9 of FIG. 9.

FIG. 14 is a partial perspective view of a belt pulling assembly of the present invention, engaging a golf bag cart handle.

### BEST MODE FOR CARRYING OUT THE INVENTION

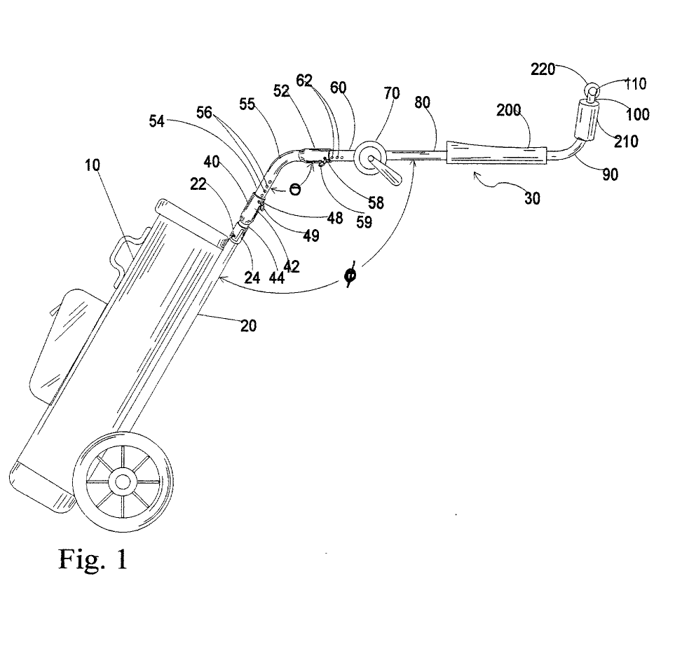

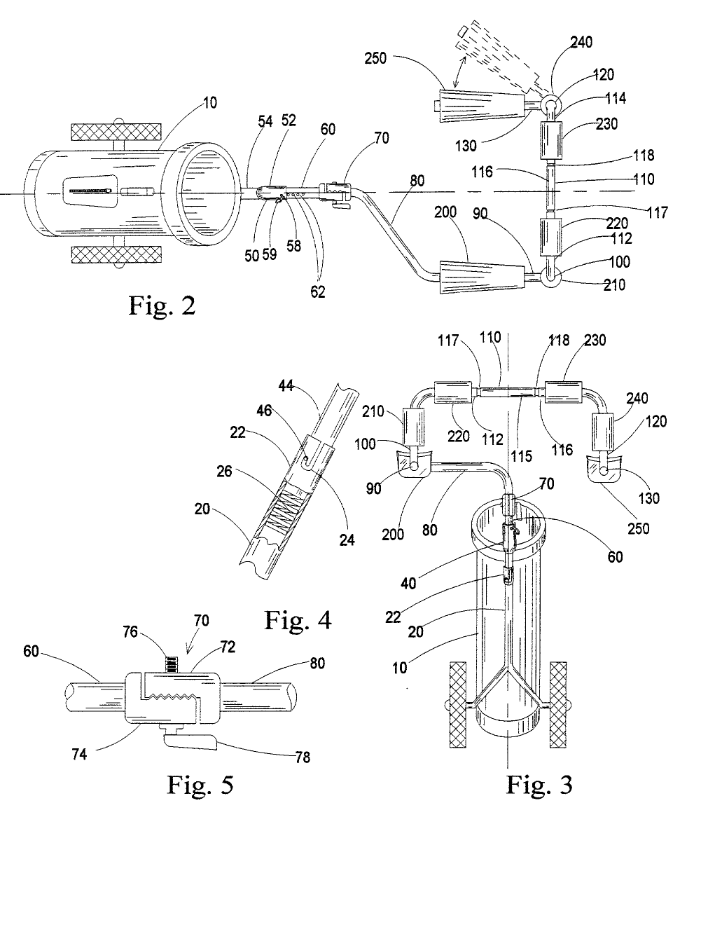

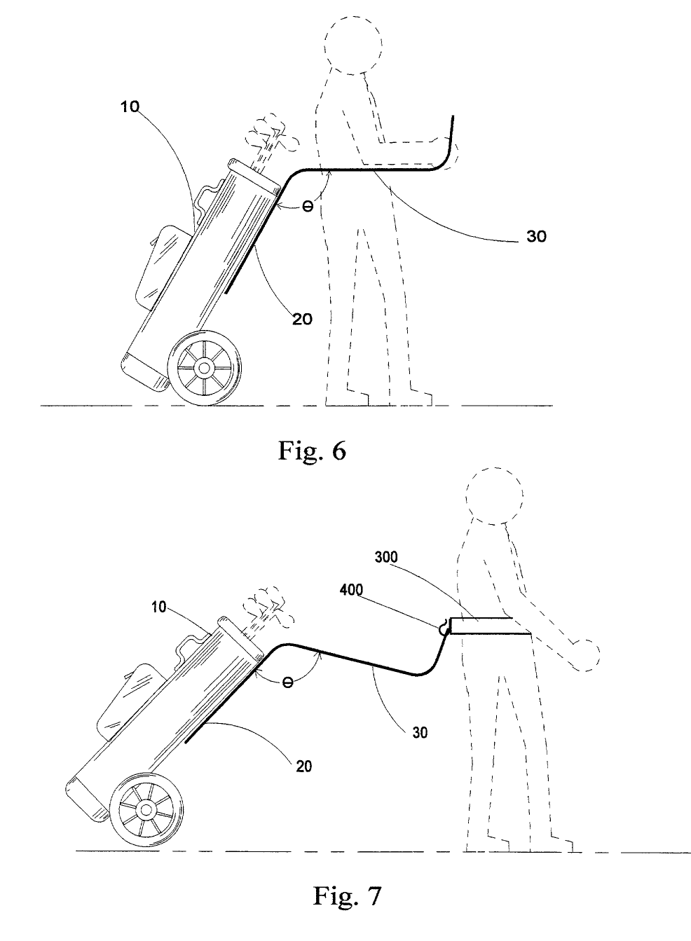

As shown in FIGS. 1, 2, and 3, handle assembly 30 attaches to golf bag cart 10 via receiving tube 20 which is fixedly attached to golf bag cart 10. Receiving tube 20 may be attached to a lateral side or the “upper” side of golf bag cart 10 instead of being attached as shown in FIGS. 1-3. Also, receiving tube 20 need not necessarily extend the entire length of golf bag cart 10, but may start near the middle and extend toward the open end of the golf bag, for example. Handle assembly 30 is composed of connecting assembly 40, height-adjustment assembly 50, length-adjustment link 60, tilting assembly 70, outward member 80, first horizontal member 90, first vertical member 100, transverse horizontal member 110, second vertical member 130, and optionally second horizontal member 130. Considering the top plan view shown in FIG. 2, it will be seen that a golfer's torso can fit in the space between outward member 80 and transverse horizontal member 110, so that the handle assembly 30 extends from the golf bag cart around at least a portion of the golfer's body, from the posterior of the golfer's body to the anterior of the golfer's body (facing horizontal member 110). See FIG. 6. To accommodate this positioning of the golfer while the golfer is using the invention, it will be understood that the top plan view of handle assembly 30 preferably will generally resemble a “J”, “7” or question mark “?.” Such shapes are preferred over top-view shapes that would completely surround the golfer, such as a loop or teardrop shape, which would be otherwise functionally equivalent, but less convenient to use and therefore not preferred.

Connecting assembly 40 is provided so handle assembly 30 may be used on rental golf bag carts as well as personal golf bag carts and for ease of transport. Connecting assembly 40 comprises a larger-diameter swaged end 42 and smaller-diameter connecting end 44. As may be seen in FIG. 4, receiving tube 20 has hollow receiving end 22 having a J-shaped slot 24 and spring 26. The diameter of receiving end 22 of receiving tube 20 is larger than the diameter of connecting end 44 of connecting assembly 40. Connecting end 44 has engaging pin 46 for engaging J-shaped slot 24. Connecting end 44 is forcibly held in position by spring 26. Hollow swaged end 42 of connecting assembly 40 has retaining-pin capture through-hole 48 for receiving retaining pin 49 which will detachably fasten connecting assembly 40 to height-adjustment assembly 50.

Height-adjustment assembly 50 is comprised of larger-diameter hollow swaged end 52, connecting end 54, and bent middle portion 55. Middle portion 55 is preferably bent at an angle θ to keep handle assembly 30 generally horizontal relative to the ground and to keep golf bag cart 10 tilted toward the golfer when in use. Angle θ may be any suitable angle, preferably between about 90° and about 270°. However, it will be recognized that angle θ may be made equal to 180°, thus essentially eliminating the bend, and allowing the handle assembly to extend from golf bag cart 10 more directly toward the gripped end of the handle assembly. In this case, the golf bag cart, while being transported, would tend to make a smaller angle with a horizontal plane (e.g., the ground) than is shown in FIG. 1.

Connecting end 54 has plurality of height-adjustment through-holes 56. Connecting end 54 of height-adjustment assembly slides into hollow swaged end 42 of connecting assembly and is held in place by retaining pin 49. Hollow swaged end 52 of height-adjustment assembly 50 has retaining-pin capture through-hole 58 for receiving retaining pin 59. Height-adjustment assembly 50 is fastened detachably to connecting assembly 40 by inserting connecting end 54 of height-adjustment link 50 into hollow swaged end 42 of connecting assembly 40, aligning retaining-pin capture through-hole 48 with one of the height-adjustment through-holes 56, and inserting retaining pin 49 through both holes.

Length-adjustment link 60, having a plurality of length-adjustment through-holes 62, is of a smaller diameter than hollow swaged end 54 of height-adjustment assembly 50 and will slide into swaged end 54. Length-adjustment link 60 is detachably fastened to height-adjustment assembly 50 by inserting length-adjustment link 60 into hollow swaged end 52 of height-adjustment assembly 50, aligning retaining-pin-capture through-hole 58 with one of the length-adjustment through-holes 62, and inserting retaining pin 59 through both holes.

As shown in FIG. 5, length-adjustment link 60 is fixedly attached to tilting assembly 70. Tilting assembly 70 allows for variable adjustment of the angle φ (indicated in FIG. 1) between handle assembly 30 and golf bag cart 10. In other words, angle φ is defined as the angle between the horizontal member of handle assembly 30 and the major longitudinal axis of the golf cart bag. As discussed above with respect to angle θ, angle φ may also be made equal to 180° (whether or not angle θ is equal to 180°). Front serrated disc 72 adjustably engages rear serrated disc 74 and the two are maintained in contact by screw 76 which is tightened by handle 78.

Outward member 80 is fixedly attached to front serrated disc 72 of tilting member 70. Outward member 80 is integrally attached to first horizontal member 90. The outward member bends away from the major longitudinal axis of the golf bag cart 10, in order to allow handle assembly 30 to wrap at least partially around the golfer so the golfer may position himself within the handle in order to pull the golf bag cart, as may be seen in FIG. 6.

First vertical member 100 is integrally attached to first horizontal member 90 and tilts up and away from first horizontal member 90. First vertical member 100 may be gripped by the golfer's hand, and first horizontal member 100 may be used to position or rest the golfer's elbow.

First vertical member 100 is integrally attached to transverse horizontal member 110. Transverse horizontal member 110 is essentially perpendicular to the major longitudinal axis formed by alignment of golf bag cart 10 and handle assembly 30. Transverse horizontal member 110 has a first end 112, middle portion 114, and second end 116. Ends 112 and 116 offer alternative hand grip locations. Optional annular groves 117 and 118 may be formed in middle portion 114 of transverse horizontal member 110 as attachment points for a pulling belt that will be described below.

Optional second vertical member 120 is integrally attached to transverse horizontal member 110 and tilts down from transverse horizontal member 110. Second vertical member offers a second grip position for the golfer's hand on this side of handle assembly 30.

Optional second horizontal member 130 is optionally pivotably attached to second vertical member 120 and rotates either away or down in order to allow ease of entrance and exit by the golfer into handle assembly 30, and may be used to position the golfer's elbow.

Dimensions are generally not critical. The overall length of handle assembly 30 need only be long enough to extend forward from the forward end of golf bag cart 10 by at least the posterior-to-anterior dimension of the golfer and slightly more to allow for comfortable positioning of the golfer while using the invention. When golf bag cart 10 is in its generally upright normal stationary position, the position of transverse horizontal member 110 should be low enough for a golfer too reach while standing on the ground next to golf bag cart 10. A preferred overall length is such that transverse horizontal member 110 is positioned at about the waist level of the golfer when in use. Thus, there is an easily recognized range of overall lengths suitable for handle assembly 30.

Receiving tube 20, connecting assembly 40, height-adjustment assembly 50, length-adjustment link 60, outward member 80, first horizontal member 90, first vertical member 100, transverse horizontal member 110, second vertical member 120, and second horizontal member 130 may be formed from solid aluminum, solid plastic, solid fiberglass, tubular aluminum, tubular steel, tubular plastic, and tubular fiberglass and finished by painting, anodizing in various colors, or chrome- or brass plating. Tilting assembly 70 may be fabricated from metal, plastic, or fiberglass.

Also shown in FIGS. 1, 2, and 3 are optional first elbow pad 200, first vertical hand grip pad 210, first horizontal hand grip pad 220, second horizontal hand grip pad 230, second vertical hand grip pad 240, and second elbow pad 250. Horizontal hand grip pads 220 and 230 may be combined into one pad, which may also serve to contact or rest on the front of a golfer, especially when the golfer is transporting the golf bag cart uphill. These pads may be fabricated from resilient material such as rubber, leather, foam, or the like.

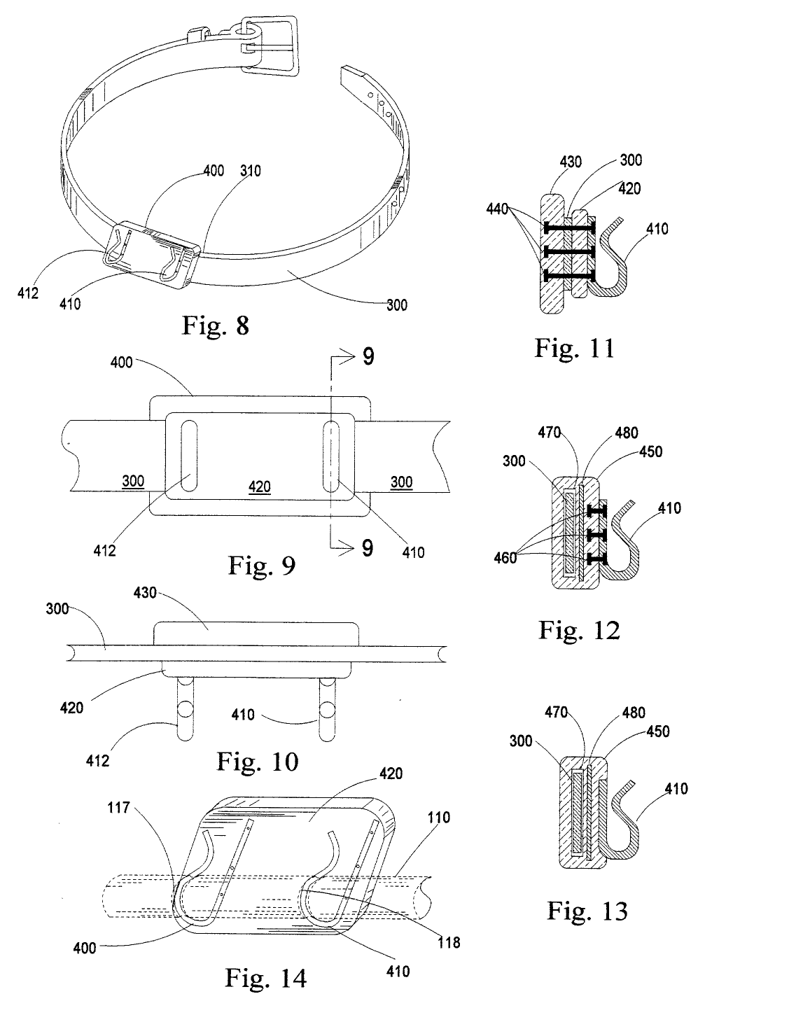

FIG. 7 shows an alternative method of transporting golf bag cart 10, by engaging handle assembly 30 with belt-mounted pulling assembly 400. FIG. 8 shows pulling assembly 400 attached to the back center portion 310 of belt 300. FIGS. 9, 10, and 11 show a first embodiment of pulling assembly 400. Clips 410 and 412 are fastened to clip mount 420 and pad 430 by rivets 430 passing through belt 300. Clips 410 and 412 may be fabricated from aluminum, rubber-coated aluminum, stainless steel, spring steel, rubber-coated spring steel, or plastic.

FIG. 12 shows a second embodiment of pulling assembly 400 wherein clips 410 and 412 are attached to molded body 450 by rivets 460 embedded in molded body 450. Molded body 450 has passage 470 to allow threading of belt 300 through, and has an optional stiffener 480. Molded body 450 may be formed from resilient rubber, resilient plastic, rubber-coated cast plastic or rubber-coated cast metal. When formed of resilient materials, the softer the material the more the need for a stiffening element or stiffener 480. Stiffeners 480 may be fabricated from aluminum, steel, or spring steel.

FIG. 13 shows a third embodiment of pulling assembly 400, wherein clips 410 and 412 are molded into molded body 410.

FIG. 14 shows how belt pulling assembly 400 engages handle assembly 30. Clips 410 and 412 engage annular grooves 112 and 117 on transverse horizontal member 110 of handle assembly 30.

While FIGS. 6 and 7 both show the golf bag cart in the preferred disposition behind the golfer, the construction of the present invention does not prevent the golfer from positioning the golf bag cart in front of him or her and pushing it forward, if the golfer prefers to operate it in that manner.

### Industrial Applicability

The applications of the invention include both detachable and permanently mounted handles for moving golf bag carts used to transport golfing equipment around a golf course. The invention provides a handle having features that allow less stressful pulling or pushing of the golf bag cart, thus reducing fatigue of the golfer's hands and arms. This allows better performance by the golfer and improves the golfer's enjoyment of the sport.

The description of the embodiments of the present invention is given above for the understanding of the present invention. It will be understood that the invention is not limited to the particular embodiments described herein, but is capable of various modifications, rearrangements, and substitutions without departing from the scope of the invention. For example, the handle may be made in forms specifically intended for right-handed or left-handed golfers, or may be made in a form to extend over a shoulder of the golfer instead of extending laterally around the golfer's torso, and the handle portion to be held for pushing may be made Y- or T-shaped. Also, various features may be eliminated to save costs, such as the detachability of the handle, the height-adjustment feature, the length-adjustment feature, and the tilt-adjustment feature. The arrangement of components may be varied, such as placing the length-adjustment feature after the tilt feature. Therefore it is intended that the following claims cover all such modifications and changes as fall within the true spirit and scope of the invention.

Having described our invention, we claim:

1. A handle for a golf bag cart for use by a golfer while transporting a golf bag load, said handle having a gripping portion for gripping by said golfer, and said gripping portion being disposed adjacent to a forward end of said handle and forward of said golfer while said golf bag load is carried behind said golfer.

2. A golf bag cart comprising a handle as recited in claim 1.

3. A handle for a golf bag cart having a major longitudinal axis, comprising:
a) a connecting member having a lower end attached to said golf bag cart, a middle portion optionally bent at an angle θ in the vertical plane, and a upper end;
b) an outward member having a first end and a second end, connected at said first end to said upper end of said connecting member and bending in a substantially horizontal plane away from a vertical plane containing the major longitudinal axis of the golf bag cart; and
c) a transverse horizontal member having a first end, a middle portion, and a second end, connected by said first end to said second end of said outward member, said transverse horizontal member being aligned substantially perpendicular to said major longitudinal axis of said golf bag cart.

4. A handle for a golf bag cart as in claim 3, further comprising:
d) a first substantially vertical member having a first end and a second end, disposed between said outward member and said transverse horizontal member, connected at said first end to said outward member and bending upward from said substantially horizontal plane.

5. A handle for a golf bag cart as in claim 4, further comprising:
e) a second substantially vertical member, having a first end and a second end, attached by said first end to said second end of said transverse horizontal member and bending downward from said transverse horizontal member.

6. A handle for a golf bag cart as in claim 3, further comprising:
a first horizontal member having a first end and a second end, integrally attached by said first end to said second end of said outward member, said first horizontal member being substantially aligned to the vertical plane containing the major longitudinal axis of said golf bag cart.

7. A handle for a golf bag cart as in claim 6, further comprising: means for adjusting an angle φ wherein said angle φ is defined as the angle between said first horizontal member and said major longitudinal axis of said golf bag cart.

8. A handle for a golf bag cart as in claim 6, further comprising:
a second horizontal member attached by a first end to said second end of said second vertical member, said second horizontal member being substantially aligned to the vertical plane containing the major longitudinal axis of said golf bag cart.

9. A handle for a golf bag cart as in claim 8, further comprising:
a first elbow pad positioned on said first horizontal member and a second elbow pad positioned on said second horizontal member;
a first vertical hand grip pad positioned on said first substantially vertical member and a second vertical hand grip pad positioned on said second substantially vertical member; and
a first horizontal hand grip pad positioned on said first end of said transverse horizontal member and a second horizontal hand grip pad positioned on said second end of said transverse horizontal member.

10. A handle for a golf bag cart as in claim 8, wherein said second horizontal member is rotatably attached to said second end of said second substantially vertical member.

11. A handle for a golf bag cart as in claim 3, wherein said connecting member is removable from said golf bag cart.

12. A handle for a golf bag cart as in claim 3, further comprising:
means for increasing the length of said lower end of said connecting member to increase the vertical distance between said handle and said golf bag cart; and means for increasing the length of said upper end of said connecting member to increase the horizontal distance between said handle and said golf bag cart.

13. A handle for a golf bag cart as in claim 12, further comprising: means for adjusting an angle φ wherein said angle φ is defined as the angle between said first horizontal member and said major longitudinal axis of said golf bag cart.

14. A handle for a golf bag cart as in claim 13, wherein said angle φ is adjustable in a range from 0 to about 180°.

15. A handle for a golf bag cart as in claim 6, further comprising:
means for increasing the length of said lower end of said connecting member to increase the vertical distance between said handle and said golf bag cart;
means for increasing the length of said upper end of said connecting member to increase the horizontal distance between said handle and said golf bag cart; and
means for adjusting an angle φ wherein said angle φ is defined as the angle between said first horizontal member and said major longitudinal axis of said golf cart bag.

16. A handle for a golf bag cart as in claim 3, wherein said handle is fabricated from material selected from the group consisting of solid aluminum, solid plastic, solid fiberglass, tubular aluminum, tubular steel, tubular plastic, and tubular fiberglass.

17. A handle for a golf bag cart as in claim 3, further comprising a belt-mounted pulling assembly detachably attached to said middle portion of said transverse horizontal member.

18. A handle for a golf bag cart as in claim 17, wherein said belt-mounted pulling assembly detachably attaches to said middle portion of said transverse horizontal member by a pair of clips.

19. A handle for a golf bag cart as in claim 18, wherein said pair of clips engage a pair of annular grooves formed in said middle portion of said transverse horizontal member.

20. A handle for a golf bag cart as in claim 17, wherein said belt-mounted pulling system is molded.

21. A handle for a golf bag cart as in claim 17, wherein said belt-mounted pulling system is formed from material selected from the group consisting of resilient rubber, resilient plastic, rubber-coated cast plastic and rubber-coated cast metal.

22. A handle for a golf bag cart as in claim 17, further comprising a stiffening element.

23. A belt-mountable pulling assembly for detachably attaching to a golf bag cart, said golf bag cart having a handle with a transverse horizontal member, said belt-mountable pulling assembly comprising:
a molded element having at least one slot for passage of a belt, and
a pair of generally J-shaped upwardly opening clips for engaging said transverse horizontal member of said handle of said golf bag cart.

24. A handle for a golf bag cart having a major longitudinal axis, comprising:
a) a connecting member having a lower end attached to said golf bag cart, a middle portion, and a upper end;
b) an outward member, having a first end and a second end, attached by said first end to said upper end of said connecting member and bending away from a vertical plane containing the major longitudinal axis of the golf bag cart in a substantially horizontal plane;
c) a first horizontal member, having a first end and a second end, integrally attached by said first end to said second end of said outward member, said first horizontal member being substantially aligned parallel to the vertical plane containing the major longitudinal axis of said golf bag cart;
d) a first vertical member, having a first end and a second end, integrally attached by said first end to said second end of said first horizontal member and bending upward from said first horizontal member;
e) a transverse horizontal member, having a first end, a middle portion, and a second end, integrally attached by said first end to said second end of said first vertical member, said transverse horizontal member being substantially aligned perpendicular to said major longitudinal axis of said golf bag cart;
f) a second vertical member, having a first end and a second end, integrally attached by said first end to said second end of said transverse horizontal member and bending downward from said transverse horizontal member; and
g) a second horizontal member attached by a first end to said second end of said second vertical member, said second horizontal member being substantially aligned parallel to the vertical plane containing the major longitudinal axis of said golf bag cart.
